(19) United States
(12) Patent Application Publication
(10) Pub. No.: US 2026/0128587 A1
(43) Pub. Date: May 7, 2026

(54) ELECTRICAL KILLSWITCH

(71) Applicant: Optiver IP B.V., Amsterdam (NL)

(72) Inventor: Dennis Fleurbaaij, Austin, TX (US)

(73) Assignee: `, (omitted)

(21) Appl. No.: 19/117,596

(22) PCT Filed: Oct. 3, 2023
(86) PCT No.: PCT/NL2023/050515

§ 371 Date: Apr. 1, 2025

(30) Foreign Application Priority Data
Oct. 4, 2022 (NL) 2033218

(51) Int. Cl. H02J 3/001; H02J 3/38

(52) U.S. Cl. CPC H02J 3/001; H02J 3/38

(57) ABSTRACT

A system for cutting power to one or more powered devices comprises an actuator which controls the power to the one or more powered devices. The actuator is, or one or more controllers connected to the actuator are, configured to receive a kill command over a network and the actuator is configured to cut power to the one or more powered devices when the actuator or at least one of the one or more controllers receives the kill command. The actuator is, or the one or more controllers are, configured to receive a heartbeat signal over the network and the actuator is configured to cut power to the one or more powered devices when the actuator, or all of the controllers if applicable, are no longer receiving the heartbeat signal.

### FIELD OF THE INVENTION

The invention relates to a system for cutting power to one or more devices.

### BACKGROUND OF THE INVENTION

In certain situations, it is important to cut power to a powered device with high reliability. For example, US2014/126594 discloses a killswitch system for a laser. As soon as the system detects a failure, it cuts power to the laser for safety reasons. In trading, this importance became apparent in 2012 when Knight Capital tried, but failed, to stop its trading systems.

Cutting power to computer and network systems guarantees that they stop immediately, which guarantees the termination of misbehaving or unexpected behavior. While Power Distribution Units (PDUs) exist that can be switched on and off remotely, e.g. the APC Rack PDU 9000 switched (e.g. APDU9941), these PDUs are not designed to fail in an appropriate way; upon loss of connection they become uncontrollable themselves.

### SUMMARY OF THE INVENTION

It is an objective of the invention to provide a system, which can cut power to a powered device, e.g. mounted in a rack, after loss of control over the powered device.

In a first aspect of the invention, a system for cutting power to one or more powered devices comprises an actuator which controls the power to said one or more powered devices. Said actuator is, or one or more controllers connected to said actuator are, configured to receive a kill command over a network and said actuator is configured to cut power to said one or more powered devices when said actuator, or at least one of said one or more controllers, receives said kill command. Said actuator is, or said one or more controllers are, configured to receive a heartbeat signal over said network and said actuator is configured to cut power to said one or more powered devices when said actuator is, or all of said one or more controllers are, no longer receiving said heartbeat signal.

Thus, the actuator will cut power if the actuator or controller is commanded to, and will also cut power if the actuator is not receiving the heartbeat signal or none of the one or more controllers is receiving the heartbeat signal.

This killswitch system is an out-of-band system which may be used to power down most infrastructure in a colocation. No power means that the electrical devices connected to the switch will not be able to operate, which is the required effect. A killswitch system is preferably placed in the area of least change, which in co-locations are the racks and power distribution units. They are often installed only once at build time and are then stable for the lifetime of the rack, which can be decades. Racked equipment like servers and network connections changes at a much higher pace.

When a heartbeat signal is no longer received over the network by the actuator or by a controller, this might imply that the actuator or the controller cannot receive kill commands either. In this situation, the actuator or the controller will fail-safe and shut off the power to the powered device(s) via the actuator.

Said system may comprise said one or more controllers and said actuator may be configured to cut power to said one or more powered devices when it loses connection to all of said one or more controllers. This is an additional fail-safe.

Said system may comprise said one or more controllers, said one or more controllers may comprise multiple controllers, and said multiple controllers may be connected to said actuator, wherein said multiple controllers are configured to receive said kill command over said network and said actuator is configured to cut power to said one or more powered devices when at least one of said multiple controllers receives said kill command, and wherein said multiple controllers are configured to receive a heartbeat signal over said network and said actuator is configured to cut power to said one or more powered devices when all of said multiple controllers are no longer receiving said heartbeat signal.

If one or more controllers are used, it is especially beneficial to let multiple controllers control the one or more actuators. This may be used to provide redundancy in case of a single communication error. In this case, the actuator(s) will only cut power when all controllers fail to receive heartbeats. One controller receiving a kill command will cause all actuators to cut power, irrespective if the other controllers have received similar kill commands.

It is also cost efficient to let a controller control multiple actuators. For example, said system may further comprise a further actuator which controls the power to one or more further powered devices, said further actuator may be connected to said one or more controllers, said further actuator may be configured to cut power to said one or more further powered devices when at least one of said one or more controllers receives said kill command, and said further actuator may be configured to cut power to said one or more further powered devices when all of said one or more controllers are no longer receiving said heartbeat signal. Said actuator, said further actuator, and said one or more controllers may be connected to each other via a bus or a local network, for example.

Said system may comprises said one or more controllers and each respective controller of said one or more controllers may be configured to receive said heartbeat signal over said network and, upon determining that said respective controller is no longer receiving said heartbeat signal, stop transmitting a signal to said actuator. Said actuator may be configured to cut power to said one or more powered devices when said actuator is not receiving said signal from any of said one or more controllers. Said signal may be an analog signal, for example. Said signal may be transmitted over a bus, for example. For instance, a controller may transmit the signal by connecting a power source to a control signal wire of the bus. The controller may then disconnect the power source from the control signal wire to stop transmitting the signal. This ensures that that the actuator(s) will only cut power when all controllers fail to receive heartbeats if said controllers are configured to not transmit the signal upon loss of heartbeats.

Each respective controller of said one or more controllers may be configured to, upon determining that said respective controller has received said kill command, stop transmitting said signal to said actuator and prevent said actuator from receiving said signal from any one other controller of said one or more controllers. For example, a controller may connect the control signal wire of the bus to ground. This will not only cause the controller to stop transmitting the signal, but also prevent the actuator from receiving the signal when another controller is transmitting the signal. This ensures that receiving a single kill command will cause the actuator to cut power, irrespective whether if the other controllers have received similar kill commands.

Each respective controller of said one or more controllers may be configured to generate a watchdog signal, receive said watchdog signal, and, upon determining that said respective controller is no longer receiving said watchdog signal, stop transmitting said signal to said actuator. Said watchdog signal may be generated by a microprocessor of a controller or by a separate watchdog circuit of said controller, for example. This is an additional fail-safe to ensure that the actuator cuts power when all controllers fail. The controller may disconnect the power source from the control signal wire of the bus to stop transmitting the signal, for example.

Said system may comprise said one or more controllers and each respective controller of said one or more controllers may be configured to receive said heartbeat signal over said network and, upon determining that said respective controller is no longer receiving said heartbeat signal, transmit a signal to said actuator. Said actuator may be configured to cut power to said one or more powered devices when said actuator has received said signal from all of said one or more controllers. Said signal may be a digital signal, for example. Said signal may be transmitted over a local network, for example. This ensures that that the actuator(s) will only cut power when all controllers fail to receive heartbeats.

Each respective controller of said one or more controllers may be configured to transmit a further signal to said actuator upon determining that said respective controller has received said kill command. Said actuator may be configured to cut power to said one or more powered devices when said actuator receives said further signal from at least one of said one or more controllers. This ensures that one of the controllers receiving a kill command will cause the actuator to cut power, irrespective whether the other controllers have received similar kill commands. Said further signal may be a digital signal, for example.

Each respective controller of said one or more controllers may be configured to generate a watchdog signal, receive said watchdog signal, and, upon determining that said respective controller is no longer receiving said watchdog signal, transmit said signal to said actuator. Said watchdog signal may be generated by a microprocessor of a controller or by a separate watchdog circuit of said controller, for example. This is an additional fail-safe to ensure that the actuator cuts power when all controllers fail.

Said one or more controllers may comprise a first controller and a second controller and said first controller and said second controller may be powered by different power supplies. This may be used to ensure that a failure of a single power supply does not result in both controllers shutting down, thereby causing the power to the one or more powered devices to be cut. Moreover, by not making an actuator responsible for supplying power to the controller(s), a dependency chain is prevented in which one controller could cause another controller to be switched off.

Said actuator may be powered from two independent mains sources. This may be used to ensure that a failure of a single mains source does not result the in the actuator not being able to provide power to the one or more powered devices when it wants to provide power to the one or more powered devices, i.e. when it is not controlled by a controller (or multiple controllers) to cut power to the one or more powered devices.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 is a block diagram of an embodiment of the controller of FIG. 1;

FIG. 3 is a block diagram of a second embodiment of the system; and

FIG. 4 is a block diagram of a third embodiment of the system;

Corresponding elements in the drawings are denoted by the same reference numeral.

### DETAILED DESCRIPTION OF THE DRAWINGS

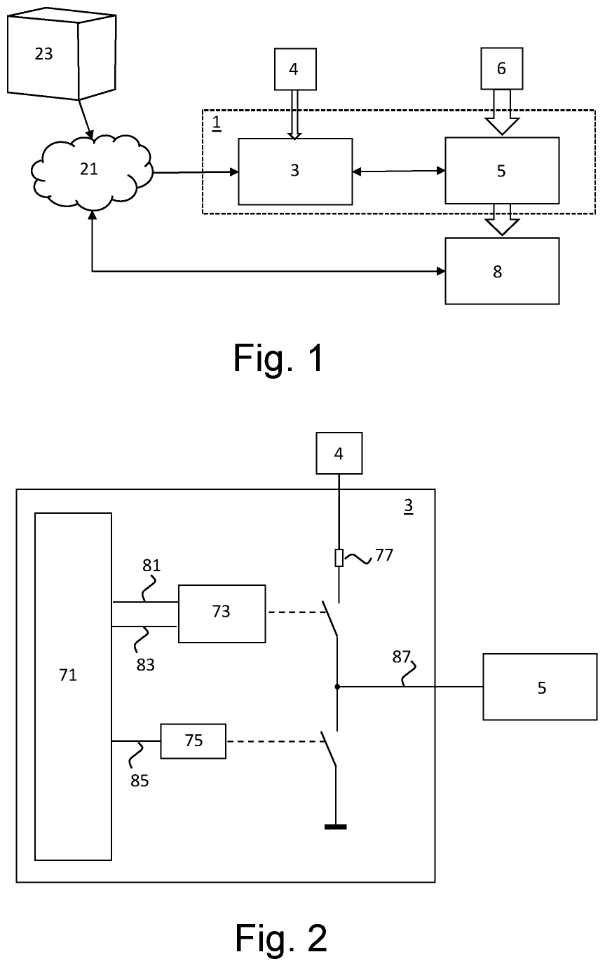

A first embodiment of the system for cutting power to one or more powered devices is shown in FIG. 1. FIG. 1 shows a system 1 which comprises an actuator 5 which controls the power to a powered device 8, e.g. a server in a rack, and a controller 3 connected to the actuator 5. The controller 3 receives power from a power supply 4 and the actuator 5 receives power from a mains power source 6; these may be different power circuits.

The controller 3 is configured to receive a kill command over a network 21, e.g. the Internet, and the actuator 5 is configured to cut power to the powered devices 8 when the controller 3 receives the kill command. The controller 3 is further configured to receive a heartbeat signal over the network 21 and the actuator 5 is further configured to cut power to the powered devices 8 when the controller 3 is no longer receiving the heartbeat signal.

In other words, system 1 is a killswitch/dead man's switch which triggers power-down on a lack of communications (heartbeats) from the further system 23. In the example of FIG. 1, the kill command and the heartbeat signal are received from a further system 23.

In a typical scenario, the further system 23 tries to communicate with the powered device 8, but is not able to get a response or to get the expected response from the power device 8. In this scenario, the further system 23 transmits a kill command to the controller 3, i.e. instructs the controller 3 to cut power to the powered device 8, either automatically or in response to user input. If the further system 23 is no longer able to contact powered device 8, it may still be able to contact controller 3.

If the controller 3 does not receive the heartbeat signal, the system cuts power to the powered device 8 automatically. This might happen even before the further system 23 tries to communicate with the powered device 8 and even works if the controller 3 can no longer be contacted. In this case, it may be assumed that when the controller 3 can no longer be contacted, the powered device 8 can also no longer be contacted.

In an alternative embodiment, the system does not comprise a controller. Instead, the actuator 5 is configured to receive a kill command over the network 21 and cut power to the powered device 8 when the actuator 5 receives the kill command. The actuator 5 is further configured to receive a heartbeat signal over the network 21 and cut power to the powered device 8 when the actuator 5 is no longer receiving the heartbeat signal.

FIG. 2 shows an embodiment of controller 3 of FIG. 1 which features a simple analog design to control the actuator. In the embodiment of FIG. 2, the controller 3 comprises a microcontroller 71, a switch 73, a switch 75, and a pull-up resistor 77. The signal generated by the controller 3 is output to the actuator 5 via a bus 87.

In the embodiment of FIG. 2, the bus 87 includes at least 2 wires to the actuator 5: a control signal and a ground (0V). The control signal controls the mains relay in the actuator 5. The wire carrying the ground signal is not shown in FIG. 2 for the sake of simplicity. In the embodiment of FIG. 2, the control signal has two possible states:
High state: this causes the mains relay of the actuator 5 to be closed; the powered device 8 (shown in FIG. 1) receives power.
Low state: this causes the mains relay of the actuator 5 to be open; the powered device 8 does not receive power.

The controller 3 receives power from power supply 4. The controller 3 will drive the control signal wire of bus 87 via the pull-up resistor 77. The value of the pull-up resistor 77 is chosen to keep the bus voltage, under full load, above the high state threshold level.

In series with the pull-up resistor 77 is switch 73. Switch 73 is driven directly by the microcontroller GPIO (General Purpose Input/Output). If the microcontroller 71 no longer receives the heartbeat signal from the further system 23, then the microcontroller 71 generates a signal 83 to control the switch 73 to assume the open state. This would cut power to the bus which would then drain naturally to bring the control signal to the low state, at least if no other controller is present.

In the embodiment of FIG. 2, the microcontroller 71 includes a watchdog timer which generates a signal 81, e.g. a reset signal, to control the switch 73 to assume the open state when the microprocessor 71 fails. This would cause the control signal to be driven to low state. This is designed to catch errors in the microcontroller hard-and software.

In an alternative embodiment, the controller 3 comprises a separate watchdog circuit. For example, the microcontroller 71 may generate a trigger signal, which is received by this watchdog circuit. If the watchdog circuit no longer receives the trigger signal, i.e. has not received the trigger signal for a period longer than a timeout threshold, the watchdog circuit generates a control signal to control the switch 73 to assume the open state.

The switch 75 is used to ensure that the control signal is driven low when the microcontroller 71 has received a kill command. The microcontroller 71 generates a signal 85 in dependence on whether it has received a kill command. When the controller 3 functions properly and the powered device 8 should be powered, the controller 3 will control the switch 75 to be open. When power to the powered device 8 should be cut, the controller 3 will control the switch 75 to remain closed. The switch 75 may be a TE IM23TS relay, for example.

At power up, the control signal will naturally be in the low state. After the switch 73 is closed, the control signal wire of the bus 87 will be pulled high through the pull-up resistor 77. If switch 75 is also closed, the bus 87 will be connected to ground and the control signal wire of the bus 87 will therefore be driven low. This pulldown has a much lower resistance than the pull up and can pull the control signal wire of the bus 87 low safely even when the control signal wire of the bus 87 will be pulled up high by closing switch 73, or when another controller is present on the bus 87 and is pulling the control signal wire of the bus 87 high.

In the embodiment of FIG. 2, the controller 3 transmits analog signals to the actuator 5, via the bus 87. In an alternative embodiment, the controller 3 transmits digital signals to the actuator 5, e.g. via a local network. For example, the actuator 5 may be configured to cut power to the powered device 8 when it does not receive a first digital control signal from any of the controllers and configured to cut power to the powered device 8 when it receives a second digital control signal from at least one of the controllers. The controller 3 may be configured to transmit the first digital control signal when it no longer receives the heartbeat signal over the network 21 and configured to transmit the second digital control signal when it receives the kill command over the network 21.

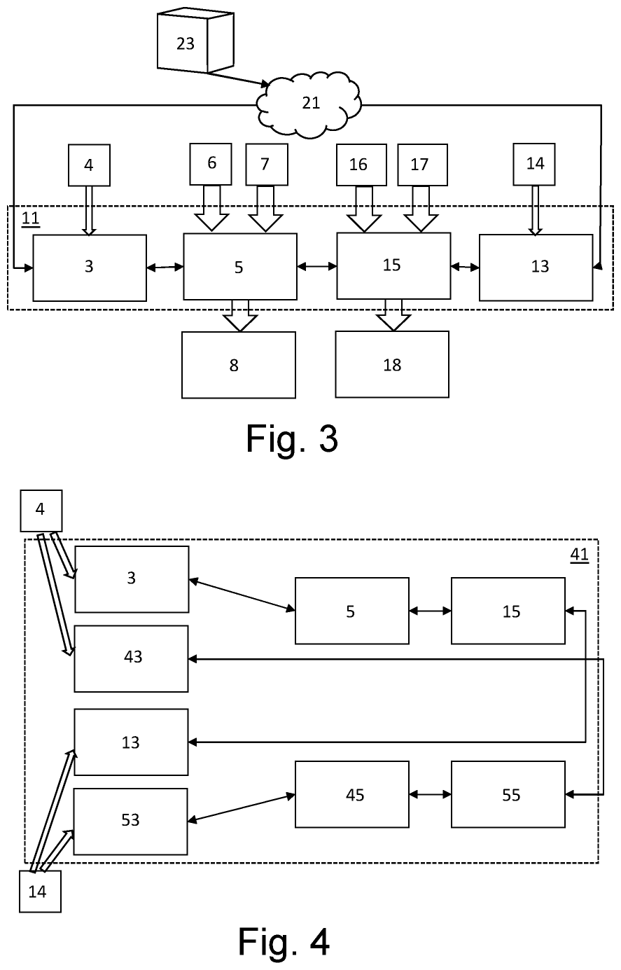

A second embodiment of the system for cutting power to one or more powered devices is shown in FIG. 3. FIG. 3 shows a system 11 which comprises the controller 3 and the actuator 5 of FIG. 1. The system 11 further comprises a further actuator 15 which controls the power to a further powered device 18. The system 11 further comprises a further controller 13. The further controller 13 is configured in the same way as the controller 3. The further actuator 15 is connected to the controllers 3 and 13.

The controllers 3 and 13 are each configured to receive a kill command over a network 21, e.g. the Internet, and the actuator 5 is configured to cut power to the powered devices 8 when the controller 3 and/or the controller 13 receives the kill command. The controllers 3 and 13 are each further configured to receive a heartbeat signal over the network 21 and the actuator 5 is further configured to cut power to the powered device 8 when both the controller 3 and the controller 13 are no longer receiving the heartbeat signal.

In the embodiment of FIG. 3, all controllers and actuators share the same control bus. Controlling the bus from two sides gives the opportunity for hot swapping any single actuator or controller. Decoupling one actuator from the bus keeps the other actuator alive, i.e. its power is not cut, because of the feed from two sides. Similarly, removing one controller will keep the bus up as the other one can feed it.

The further actuator 15 is configured in the same way as actuator 5. The further actuator 15 is configured to cut power to the further powered device 18 when at least one of controllers 3 and 13 receives the kill command. The further actuator 15 is further configured to cut power to the one or more further powered devices 18 when both the controller 3 and the controller 13 are no longer receiving the heartbeat signal.

In the embodiment of FIG. 3, the actuator 5 and the further actuator 15 are each configured to cut power to the powered device 8 and the further powered device 18, respectively, when the actuator loses connection to both the controller 3 and the controller 13.

Actuators 5 and 15 will only cut power to the one or more powered devices if communication to both controllers 3 and 13 fails, i.e. if both controllers 3 and 13 do not receive the heartbeat signal. When using the embodiment of controller 3 of FIG. 2, upon communication failure, the bus 87 of FIG. 2 will not be pulled low but will also not be fed to be high anymore. As long as one of controllers 3 and 13 pulls the bus high, the actuators 5 and 15 will not cut power to the powered devices 8 and 18. If one of controllers 3 and 13 receives a kill command, it will pull the bus down using switch 75 of FIG. 2. This will work, even if the other controller is still pulling the bus high, because of the resistive difference between the source and the drain methods.

In the embodiment of FIG. 3, the controller 3 and the further controller 13 are powered by different power supplies, i.e. power supplies 4 and 14, respectively. Furthermore, the actuator 5 is powered from two independent mains sources: mains sources 6 and 7 and the actuator 15 is powered from two independent mains sources: mains sources 16 and 17. This is used in conjunction with dual power supply feeds as commonly found in datacenters to guard against the system becoming unavailable if one of the two power feeds fails or is cut off.

A third embodiment of the system for cutting power to one or more powered devices is shown in FIG. 4. FIG. 4 shows a system 41 which comprises the controllers 3 and 13 and the actuators 5 and 15 of FIG. 3. The system 11 further comprises additional controllers 43 and 53 and additional actuators 45 and 55. The additional controllers 43 and 53 are coupled to power supplies 4 and 14, respectively. The additional actuators 45 and 55 are connected to additional controllers 43 and 53.

Controllers 3 and 13 may be responsible for all switches on the A-power side of a plurality of racks and controllers 43 and 53 may be responsible for all switches on the B-power side of the plurality of racks, for example. Controllers 3 and 43 and power supply 4 may be located in the same cabinet, for example. Controllers 13 and 53 and power supply 14 may be located in the same cabinet, for example.

The powered devices whose power supply is controlled by the actuators 5, 15, 45, and 55 are not shown in FIG. 4 for the sake of simplicity. The network 21 and the further system 23 of FIG. 3 are not shown in FIG. 4 for the sake of simplicity. The mains power sources to which actuators 5, 15, 45, and 55 are coupled are not shown in FIG. 4 for the sake of simplicity.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for cutting power to one or more powered devices, said system comprising:
an actuator which controls the power to said one or more powered devices,
wherein said actuator is, or one or more controllers connected to said actuator are, configured to receive a kill command over a network and said actuator is configured to cut power to said one or more powered devices when said actuator, or at least one of said one or more controllers, receives said kill command, and
wherein said actuator is, or said one or more controllers are, configured to receive a heartbeat signal over said network and said actuator is configured to cut power to said one or more powered devices when said actuator is, or all of said one or more controllers are, no longer receiving said heartbeat signal.

2. The system as claimed in claim 1, wherein said system comprises said one or more controllers, said one or more controllers comprise multiple controllers, and said multiple controllers are connected to said actuator, wherein said multiple controllers are configured to receive said kill command over said network and said actuator is configured to cut power to said one or more powered devices when at least one of said multiple controllers receives said kill command, and
wherein said multiple controllers are configured to receive a heartbeat signal over said network and said actuator is configured to cut power to said one or more powered devices when all of said multiple controllers are no longer receiving said heartbeat signal.

3. The system as claimed in claim 2, wherein said system comprises said one or more controllers and each respective controller of said one or more controllers is configured to receive said heartbeat signal over said network and, upon determining that said respective controller is no longer receiving said heartbeat signal, stop transmitting a signal to said actuator, and wherein said actuator is configured to cut power to said one or more powered devices when said actuator is not receiving said signal from any of said one or more controllers.

4. The system as claimed in claim 3, wherein each respective controller of said one or more controllers is configured to, upon determining that said respective controller has received said kill command, stop transmitting said signal to said actuator and prevent said actuator from receiving said signal from any one other controller of said one or more controllers.

5. The system as claimed in claim 4, wherein each respective controller of said one or more controllers is configured to generate a watchdog signal, receive said watchdog signal, and, upon determining that said respective controller is no longer receiving said watchdog signal, stop transmitting said signal to said actuator.

6. The system as claimed in claim 1, wherein said system comprises said one or more controllers and each respective controller of said one or more controllers is configured to receive said heartbeat signal over said network and, upon determining that said respective controller is no longer receiving said heartbeat signal, transmit a signal to said actuator, and wherein said actuator is configured to cut power to said one or more powered devices when said actuator has received said signal from all of said one or more controllers.

7. The system as claimed in claim 6, wherein each respective controller of said one or more controllers is configured to transmit a further signal to said actuator upon determining that said respective controller has received said kill command, and wherein said actuator is configured to cut power to said one or more powered devices when said actuator receives said further signal from at least one of said one or more controllers.

8. The system as claimed in claim 7, wherein each respective controller of said one or more controllers is configured to generate a watchdog signal, receive said watchdog signal, and, upon determining that said respective controller is no longer receiving said watchdog signal, transmit said signal to said actuator, and wherein said actuator is configured to cut power to said one or more powered devices when said actuator has received said signal from all of said one or more controllers.

9. The system as claimed in claim 1, wherein said system comprises said one or more controllers and said actuator is configured to cut power to said one or more powered devices when it loses connection to all of said one or more controllers.

10. The system as claimed in claim 1, wherein said system further comprises a further actuator which controls the power to one or more further powered devices, said further actuator is connected to said one or more controllers, said further actuator is configured to cut power to said one or more further powered devices when at least one of said one or more controllers receives said kill command, and said further actuator is configured to cut power to said one or more further powered devices when all of said one or more controllers are no longer receiving said heartbeat signal.

11. The system as claimed in claim 10, wherein said actuator, said further actuator, and said one or more controllers are connected to each other via a bus or a local network.

12. The system as claimed in claim 1, wherein said one or more controllers comprise a first controller and a second controller and said first controller and said second controller are powered by different power supplies.

13. The system as claimed in claim 1, wherein said actuator is powered from two independent mains sources.

14. The system as claimed in claim 1, wherein said system comprises said one or more controllers and each respective controller of said one or more controllers is configured to receive said heartbeat signal over said network and, upon determining that said respective controller is no longer receiving said heartbeat signal, stop transmitting a signal to said actuator, and wherein said actuator is configured to cut power to said one or more powered devices when said actuator is not receiving said signal from any of said one or more controllers.

15. The system as claimed in claim 3, wherein each respective controller of said one or more controllers is configured to generate a watchdog signal, receive said watchdog signal, and, upon determining that said respective controller is no longer receiving said watchdog signal, stop transmitting said signal to said actuator.

16. The system as claimed in claim 2, wherein said system comprises said one or more controllers and each respective controller of said one or more controllers is configured to receive said heartbeat signal over said network and, upon determining that said respective controller is no longer receiving said heartbeat signal, transmit a signal to said actuator, and wherein said actuator is configured to cut power to said one or more powered devices when said actuator has received said signal from all of said one or more controllers.

17. The system as claimed in claim 16, wherein each respective controller of said one or more controllers is configured to transmit a further signal to said actuator upon determining that said respective controller has received said kill command, and wherein said actuator is configured to cut power to said one or more powered devices when said actuator receives said further signal from at least one of said one or more controllers.

18. The system as claimed in claim 17, wherein each respective controller of said one or more controllers is configured to generate a watchdog signal, receive said watchdog signal, and, upon determining that said respective controller is no longer receiving said watchdog signal, transmit said signal to said actuator, and wherein said actuator is configured to cut power to said one or more powered devices when said actuator has received said signal from all of said one or more controllers.

19. The system as claimed in claim 6, wherein each respective controller of said one or more controllers is configured to generate a watchdog signal, receive said watchdog signal, and, upon determining that said respective controller is no longer receiving said watchdog signal, transmit said signal to said actuator, and wherein said actuator is configured to cut power to said one or more powered devices when said actuator has received said signal from all of said one or more controllers.
